(19) United States
(12) Patent Application Publication
(10) Pub. No.: US 2012/0135110 A1
(43) Pub. Date: May 31, 2012

(54) COMPOSITION FOR LOW-SALT FOOD OR BEVERAGE

(75) Inventors: Sayuri CHIBA, Kawasaki-shi (JP); Tadaaki SAEGUSA, Kawasaki-shi (JP); Mayu ISHII, Kawasaki-shi (JP)

(73) Assignee: AJINOMOTO CO. INC, Tokyo (JP)

(21) Appl. No.: 13/333,070

(22) Filed: Dec. 21, 2011

Related U.S. Application Data
(63) Continuation of application No. PCT/JP2010/061227, filed on Jun. 24, 2010.

(30) Foreign Application Priority Data
Jun. 26, 2009 (JP) 2009-152020

(51) Int. Cl. A23L 1/237; A23L 1/304

(52) U.S. Cl. 426/52; 426/649; 426/590; 426/442

(57) ABSTRACT

It is possible to adjust the balance of taste of a low-salt food or beverage and to impart good taste to the low-salt food or beverage for general purposes without the need of imparting a salty taste to the low-salt food or beverage, by adding a hydrolysate of a plant-derived protein and an yeast extract are added to a low-salt food or beverage.

### CROSS REFERENCES TO RELATED APPLICATIONS

This application is a continuation of International Patent Application No. PCT/JP2010/061227, filed on Jun. 24, 2010, and claims priority to Japanese Patent Application No. 152020/2009, filed on Jun. 26, 2009, both of which are incorporated herein by reference in their entireties.

### BACKGROUND OF THE INVENTION

1. Field of the Invention

The present invention relates to compositions that contain a hydrolyzed vegetable protein and a yeast extract for use in reduced-salt foods and beverages. The present invention also relates to reduced-salt foods and beverages which contain such a composition and methods for producing low-salt foods and beverages.

2. Discussion of the Background

Salt is widely used as a basic flavor enhancer for seasoning food. On the other hand, excessive salt intake is known to have adverse effects on high-blood pressure and circulatory diseases such as heart disease. In view of this background, there are commercial products such as salt substitutes, low-salt or reduced-salt flavor enhancers, and processed foods with low-salt or reduced-salt. A problem of such products, however, is the lack of good taste, for example, a plain taste and flavor, and disrupted taste balance, owning to the lack of saltiness.

As a solution to this problem, a method that uses a salt substitute and a saltiness enhancer is available as a method intended to maintain good taste by supplementing the salty taste with a substance other than salt, or a salt reducing method, as it is generally called. The salt substitute is a substance that has a salty taste by itself. The saltiness enhancer is a substance that does not have a salty taste itself, but enhances the salty taste of the coexisting salt. To date, many salt substitutes and saltiness enhancers have been reported.

The main component of many salt substitutes is potassium chloride. Potassium chloride has a characteristic bitterness and harsh taste. There are reports that the bitterness and harsh taste can be suppressed by mixing one or several components selected from glutamate, amino acid, organic acid salt, nucleic acid-based umami substance, and high sweeteners such as glycyrrhizin (see JP-A-57-138359, JP-A-59-187761, and JP-A-11-187841). However, these techniques do not sufficiently suppress the bitterness and harsh taste of potassium chloride, and involve a problem, which is the exhibition of undesirable tastes such as an acid taste.

The saltiness enhancer is not a salt substitute, but enhances the salty taste of salt. There are reports of mixing one or several components selected from protein hydrolysates, sugars, organic acid salts, inorganic salts, and amino acids (see JP-A-07-289198, JP-A-2008-99624, JP-A-2007-289145, JP-A-03-139257, JP-A-63-137658, JP-A-62-3760, and JP-A-58-187164). However, when these materials are added to reduced-salt foods and beverages that have a 25% or higher percentage reduction of the salt content or sodium content (high salt reduction) with respect to the standard food and beverage, mixing these materials as taught by these publications cannot impart good taste to such an extent as to sufficiently satisfy palatability, because of deficiencies such as weak effects and the unnecessary tastes, such as an acid taste, imparted by these materials.

Currently, a salt substitute and a saltiness enhancer that can effectively impart good taste to complement the lost salty taste to such an extent as to satisfy palatability are not available, and low-salt or reduced-salt flavor enhancers and processed foods are not common place. Further, there are no reports of materials with which the reduced palatability (reduced good taste) due to reduced salt can be solved without imparting a salty taste. Accordingly, there is a strong need for materials that can impart good taste to reduced-salt foods and beverages while solving the foregoing problems.

### SUMMARY OF THE INVENTION

Accordingly, it is one object of the present invention to provide novel food materials that can adjust the taste balance and can impart good taste to a reduced-salt food or beverage to such an extent as to sufficiently satisfy palatability for general purposes, without the need for imparting a salty taste.

It is another object of the present invention to provide novel methods for adjusting the taste balance and imparting good taste to a reduced-salt food or beverage.

A salt substitute and a saltiness enhancer are often used to impart good taste to reduced-salt foods and beverages. However, when these materials are added to, for example, a reduced-salt food or beverage that has a 25% or higher percentage reduction of a salt amount or sodium amount (high salt reduction) with respect to the standard food or beverage, good taste cannot be imparted to such an extent as to sufficiently satisfy palatability, because of deficiencies such as weak effects and the unnecessary tastes, such as an acid taste and bitterness, imparted by these materials. In view of this background, the present invention provides food materials that can adjust the taste balance and can impart good taste to a reduced-salt food or beverage to such an extent as to sufficiently satisfy palatability for general purposes, without the need for imparting a salty taste.

These and other objects, which will become apparent during the following detailed description, have been achieved by the inventors' discovery that compositions including a mixture of a hydrolyzed vegetable protein (HVP) and a yeast extract are effective for adjusting the taste balance and imparting good taste to a reduced-salt food or beverage.

Thus, the present invention provides:

(1) A composition for a reduced-salt food or beverage, the composition including a mixture of a hydrolyzed vegetable protein (HVP) and a yeast extract.

(2) A composition for a reduced-salt food or beverage, the composition including a HVP and a yeast extract mixed in the ranges 15≦A≦97 and 3≦B≦85, where A is the weight part of the mixed amount of the HVP, B is the weight part of the mixed amount of the yeast extract, and A+B=100.

(3) A composition for a reduced-salt food or beverage, the composition including a mixture of the HVP, a yeast extract, and one or more of amino acid, nucleic acid, organic acid, inorganic salt, and sugar alcohol.

(4) A composition for a reduced-salt food or beverage, the composition including a HVP, a yeast extract, and one or more of amino acid, nucleic acid, organic acid, inorganic salt, and sugar alcohol mixed in the ranges 10≦A≦85, 3≦B≦40, and 12≦C≦50, where A is the weight part of the mixed amount of the HVP, B is the weight part of the mixed amount of the yeast extract, C is the weight part of the total mixed amount of the amino acid, the nucleic acid, the organic acid, the inorganic salt, and the sugar alcohol, and A+B+C=100.

(5) The composition for a reduced-salt food or beverage according to any one of (1) to (4), wherein the source of the vegetable protein is any one of cereals, beans, and nuts.

(6) The composition for a reduced-salt food or beverage according to any one of (1) to (4), wherein the HVP is produced by a method that includes steps corresponding to one or more of the following steps (a) to (i),

(a) a step of performing hydrolysis at a pH of 6 or less,

(b) a step of performing hydrolysis at a pH of 8 or more,

(c) a step of adding an alkaline solution to a hydrolyzed protein solution to neutralize acid, then removing sodium chloride,

(d) a step of performing enzymatic hydrolysis at a temperature of 20 to 40° C. and a pH of 6 to 9 using a liquid koji or a solid koji,

(e) a step of performing hydrolysis without a salt,

(f) a step of separating koji mold cells from the protein hydrolysis solution by centrifugation or filtration and drying the obtained solution,

(g) a step of performing decoloration by membrane treatment and/or with activated carbon,

(h) a step of concentrating at a pH of 8 or more,

(i) a step of removing a fraction with a molecular weight of 20,000 or more using a membrane, a column, or electrophoresis.

(7) The composition for a reduced-salt food or beverage according to any one of (1) to (4), wherein the yeast extract is produced by using a yeast of the genus Saccharomyces, or a torula yeast (the genus Candida).

(8) The composition for a reduced-salt food or beverage according to (7), wherein the Saccharomyces yeast is Saccharomyces cerevisiae.

(9) The composition for a reduced-salt food or beverage according to any one of (1) to (4), further including a yeast extract obtained by heating a mixture of a glutathione-containing yeast extract and sugar.

(10) The composition for a reduced-salt food or beverage according to any one of (1) to (4), wherein the yeast extract is obtained by using any one of an autolysis method, an acid degradation method, and an enzyme degradation method.

(11) The composition for a reduced-salt food or beverage according to any one of (1) to (4), wherein the yeast extract has a total nitrogen content of 7% or less.

(12) The composition for a reduced-salt food or beverage according to (3), wherein the amino acid is at least one of sodium glutamate, alanine, methionine, sodium aspartate, arginine, and lysine hydrochloride.

(13) The composition for a reduced-salt food or beverage according to (3), wherein the nucleic acid is sodium inosinate.

(14) The composition for a reduced-salt food or beverage according to (3), wherein the organic acid is at least one of trisodium citrate, succinic acid, potassium bitartrate, calcium lactate, and sodium fumarate.

(15) The composition for a reduced-salt food or beverage according to (3), wherein the inorganic salt is at least one of dipotassium hydrogen phosphate, and anhydrous potassium carbonate.

(16) The composition for a reduced-salt food or beverage according to (3), wherein the sugar alcohol is sorbitol.

(17) A food or beverage that includes the composition for a reduced-salt food or beverage of any one of (1) to (4) in 5 ppm or more and 0.65% or less at the time of eating or drinking.

(18) A reduced-salt food that includes the composition of (1) in a reduced-salt food or beverage that has a 25% or higher percentage reduction of an intake salt amount or an intake sodium amount.

(19) A method of improving the taste and flavor of a reduced-salt food or beverage, comprising adding an effective amount of a composition according to (1) to a reduced-salt food or beverage.

Note that the present invention encompasses any combination of the configurations below, and the representations of the present invention are interchangeable with regard to methods, apparatuses, and the like.

The present invention can provide a method and a composition with which good taste can be imparted to a reduced-salt food or beverage without the need for imparting a salty taste.

### DETAILED DESCRIPTION OF THE PREFERRED EMBODIMENTS

In the present invention, the term reduced-salt food or beverage means a food or beverage with an 84 mg or more reduction of the sodium amount per 100 g of the food (100 ml for liquid products), or a food or beverage with a 20% or more percentage reduction of the salt amount or sodium amount with respect to the standard food or beverage. From the standpoint of prominently exhibiting the effect of adding the composition, or more specifically, imparting a more well-balanced flavor or taste, it is more preferable that the food or beverage be a food or beverage with a 120 mg or more reduction of the sodium amount per 100 g of the food (100 ml for liquid products), or a food or beverage with a 30% or more percentage reduction of the salt or sodium with respect to the standard food or beverage.

Reduced-salt foods and beverages are defined by the Consumer Affairs Agency, Government of Japan in Article 10 and Table 6 of http://www.caa.go.ip/foods/pdf/syokuhin344.pdf, which is incorporated herein by reference in its entirety.

Further, in the present invention, the amount of intake salt in the food or beverage to which good taste is imparted is preferably 0.2% or more. A prominent effect can be obtained with 0.4% or more.

The present inventors conducted intensive studies, and found that the effect of imparting good taste to complement a loss due to insufficient salty taste remained weak when a HVP or a yeast extract is solely mixed with the reduced-salt food or beverage as defined by the present invention, but could be improved, rather surprisingly, by using the HVP and the yeast extract in combination. The present invention has been completed based on this finding.

It is important that the composition for a reduced-salt food or beverage of the present invention contains both (A) a HVP, and (B) a yeast extract. In is preferable that (C) one or more components selected from amino acids, nucleic acids, organic acids, inorganic salts, and sugar alcohols be contained with (A) the HVP, and (B) the yeast extract, because it prominently improves the effect. Specifically, a more well-balanced flavor or taste can be imparted this way. The composition for a reduced-salt food or beverage of the present invention has the effect of imparting and improving good taste by being added to a reduced-salt food or beverage. The form of the composition for a reduced-salt food or beverage is not particularly limited, and may be used in the form of for example, a powder, a solid, a paste, or a solution. Further, the composition for a reduced-salt food or beverage may be used as the raw material of a reduced-salt food or beverage, or as a flavor enhancer such as a seasoned salt, miso, soy sauce, juice, gravy, sauce, dressing, and mayonnaise with reduced-salt level.

The composition for a reduced-salt food or beverage of the present invention is characterized by the addition of a HVP and a yeast extract. When the mixed amounts of the HVP and the yeast extract are A weight part and B weight part, respectively, it is preferable that these be mixed in the ranges 0≦A≦100 and 0≦B≦100, more preferably 15≦A≦97 and 3≦B≦85, where A+B=100. Further, when adding one or more components (C) selected from amino acids, nucleic acids, organic acids, inorganic salts, and sugar alcohols, the effect can be exhibited more prominently in the ranges 10≦A≦85, 3≦B≦40, and 12≦C≦50, preferably 20≦A≦80, 5≦B≦35, and 15≦C≦45, more preferably 30≦A≦80, 5≦B≦30, and 15≦C≦40, where C is the weight part of the mixed amount of the total of the amino acid, nucleic acid, organic acid, inorganic salt, and sugar alcohol components (also may be referred to as component C in the present invention), and A+B+C=100. Specifically, this is preferable as it imparts a more well-balanced flavor or taste. The composition for a reduced-salt food or beverage of the present invention has the effect of improving good taste by being added to a reduced-salt food or beverage.

The “flavor” as used in the present invention means the aroma that wafts into the nose from the mouth while eating or drinking (retronasal flavor). Further, the “taste” as used in the present invention means the strength, continuity, and expansion of the taste felt in the mouth while eating or drinking.

The “hydrolyzed vegetable protein (HVP)” as used in the present invention collectively refers to hydrolysates obtained by hydrolysis of vegetable proteins or the like with an enzyme or an acid. Preferably, the protein originates in cereals such as wheat, rice, and corn, or beans and nuts such as soybeans, because these products have a strong titer, and can impart a well-balanced flavor or taste. Further, it is preferable that the hydrolyzed vegetable protein be produced by a method that includes steps corresponding to one or more of the steps (a) to (i) below, because it produces a stronger titer, and can impart a more well-balanced flavor and taste.

(a) a step of performing hydrolysis at a pH of 6 or less;

(b) a step of performing hydrolysis at a pH of 8 or more;

(c) a step of mixing an alkaline solution with a protein hydrolysis solution to neutralize acid, then removing sodium chloride;

(d) a step of performing enzymatic hydrolysis at a temperature of 20 to 40° C. and a pH of 6 to 9 using a liquid koji or a solid koji;

(e) a step of performing hydrolysis without a salt;

(f) a step of separating koji mold cells from the protein hydrolysis solution by centrifugation or filtration and drying the obtained solution;

(g) a step of performing decoloration by a membrane treatment and/or with activated carbon;

(h) a step of concentrating at a pH of 8 or more;

(i) a step of removing a fraction with a molecular weight of 20,000 or more using a membrane, a column, or electrophoresis.

Suitably, the molecular weight range (or distribution of molecular weight) of the hydrolyzed vegetable protein is 75 to 100,000, preferably 75 to 50,000, more preferably 75 to 20,000.

Examples of suitable hydrolyzed vegetable proteins which are commercially available include “Koji-Aji” (Ajinomoto Co., Inc.), “Koji-Aji S” (Ajinomoto Co., Inc.) and “A-1000” (Ajinomoto Co., Inc.).

The yeast extract as used in the present invention collectively refers to liquids obtained by extracting the yeast contents, or powders obtained by drying such liquids. Preferably, the yeast extract is of the genus Saccharomyces, for example, a Saccharomyces cerevisiae beer yeast, a bread yeast, a sake yeast, and a wine yeast, or of the torula yeast (Candida utilis), because these yeasts have a strong titer, and can impart a well-balanced flavor or taste. Note that the “yeast extract No. 2” (bread yeast extract, Ajinomoto Co., Inc.) used in Examples of the present invention contains Saccharomyces cerevisiae. Yeast extracts obtained by heating a mixture of glutathione-containing yeast extract and sugar are more preferable for their stronger titer and the ability to impart a more well-balanced flavor or taste. Yeast extracts with a total nitrogen content of 7% or less are also preferable for their even stronger titer and the ability to impart an even more well-balanced flavor or taste. The method for acquiring the yeast extract is not particularly limited, and is generally an autolysis method, an acid degradation method, or an enzyme degradation method.

Examples of suitable yeast extracts which are commercially available include “Yeast extract No. 1” (Ajinomoto Co., Inc.)) and “Yeast extract No. 2” (Ajinomoto Co., Inc.).

The “amino acids” as used in the present invention refers to amino acids and/or amino acid salts. For example, sodium glutamate, alanine, methionine, sodium aspartate, arginine, lysine hydrochloride are particularly preferred for their strong titer and the ability to impart a well-balanced flavor or taste.

In the present invention, the particularly preferred nucleic acid is sodium inosinate for its strong titer and the ability to impart a well-balanced flavor or taste. The “organic acids” as used in the present invention refer to organic acids and/or organic acid salts. For example, trisodium citrate, succinic acid, potassium bitartrate, calcium lactate, and sodium fumarate are particularly preferred for their strong titer and the ability to impart a well-balanced flavor or taste.

In the present invention, the inorganic salts are not particularly limited, and, for example, potassium salts, magnesium salts, calcium salts, sodium salts, and ammonia salts may be used. Dipotassium hydrogen phosphate and/or anhydrous potassium carbonate are particularly preferred for their strong titer and the ability to impart a well-balanced flavor or taste.

In the present invention, sugar alcohols are not particularly limited, and, for example, maltitol, mannitol, and sorbitol may be used. Sorbitol is particularly preferred for its strong titer and the ability to impart a well-balanced flavor or taste.

In the present invention, the concentration at the eating or drinking of a food and beverage refers to the concentration at the time of eating or drinking a food and beverage, after the food or beverage is cooked. In the present invention, the composition for a reduced-salt food or beverage is contained in the food and beverage preferably in 5 ppm or more and 0.65% or less at the time of eating or drinking, because it increases the titer, and can impart a well-balanced flavor or taste. Concentrations above or below this range are not preferable from the standpoint of imparting good taste. The effect of adding the composition for a reduced-salt food or beverage becomes weak when the concentration is below the foregoing range. Above the foregoing concentration range, an odd flavor such as an irritating odor may generate. From the standpoint of further increasing the titer and imparting a more well-balanced flavor or taste, the concentration of the composition for a reduced-salt food or beverage is preferably 0.02% or more and 0.09% or less.

The composition for a reduced-salt food or beverage used in the present invention may be mixed with a reduced-salt food or beverage or with a reduced-salt flavor enhancer at any time, and the timing is not particularly limited. The effect of imparting good taste to a reduced-salt food or beverage can be obtained regardless of whether the composition for a reduced-salt food or beverage is added to the raw material of the food or beverage or the flavor enhancer prior to production, or added during or after the production of the food or beverage or the flavor enhancer, or immediately before or while eating or drinking the food or beverage or the flavor enhancer.

Any raw material can be used for the composition for a reduced-salt food or beverage used in the present invention, as long as it is usable for food and beverage, and may be materials with various histories, including, for example, synthesized, extracted, and fermented products, and materials subjected to heat reaction.

In the present invention, the reduced-salt food or beverage to which good taste is imparted is not particularly limited. The composition for a reduced-salt food or beverage of the present invention may be used in any form, for example, by being (i) added in a flavor enhancer form to a reduced-salt food or beverage, (ii) added to a reduced-salt food or beverage after being diluted with water or a solvent, (iii) added to a reduced-salt food or beverage in the form of a protein hydrolysate or a yeast extract, (iv) mixed as the raw material of a reduced-salt flavor enhancer of a powder, solid, or liquid form, or (v) mixed as the raw material of reduced-salt processed food and reduced-salt fishery and meat processed food. Specific examples include rice, rice ball, vegetable, pickle, tempura, boiled egg, snack, cereal, saute, low-salt or reduced-salt flavor enhancers (such as seasoned salt, miso, soy sauce, juice, gravy, sauce, dressing, and mayonnaise), processed food such as soup (including soups for soup cups and instant noodles), and roux, and low-salt or reduced-salt fishery and processed meat products such as kamaboko, chikuwa, satsuma age, ham, and sausage.

Other features of the invention will become apparent in the course of the following descriptions of exemplary embodiments which are given for illustration of the invention and are not intended to be limiting thereof.

### EXAMPLES

In Examples below, sensory evaluations were performed by four well-trained special panelists with an average of more than 10 years of experience in food industry, unless otherwise stated.

### Example 1

### Confirmation of the Effect of Adding the Composition for Reduced-salt food or Beverage at Various Concentrations in Vegetable Soup System

### Preparation of Vegetable Soup.

Carrot (150 g), onion (150 g), cabbage (150 g), water (1,500 g), and salt (6 g) were placed in a pot, heated to boil over high heat, and stewed at low heat for 30 minutes after boiling. The scum was removed as it appeared while heating and stewing. After 30 minutes of stewing, the stewed soup was drained with a strainer to separate the soup from the vegetables, and the soup was used as a vegetable soup in the experiment below (intake salt concentration 0.4%).

### Addition of the Composition for Reduced-Salt Food or Beverage to Vegetable Soup at Various Concentrations.

A HVP (a dry powder obtained by spray drying an enzymatically hydrolyzed wheat solution (enzymatically hydrolyzed for at least 20 hours) after purifying the solution and removing a fraction with a molecular weight of 20,000 or more using a ultrafiltration membrane), and a yeast extract (“yeast extract No. 2,” bread yeast extract; Ajinomoto Co., Inc.) were added to the vegetable soup in the same proportions to make the total intake concentration of the two components 1 ppm, 10 ppm, 0.01%, 0.03%, 0.05%, 0.08%, 0.1%, 0.2%, 0.3%, and 0.4%. A vegetable soup without addition of these two components was used as a control.

Note that the control had a low intake salt content, and was characterized by a plain poor taste, and an unbalanced bad taste, compared to a soup that had an intake salt concentration of 0.8%, a common standard concentration. The composition for reduced-salt food of the present invention was added to this vegetable soup that had a weakly salty, plain, disrupted taste to examine the effect of adding the composition, specifically the good taste imparting effect.

Sensory evaluations were made based on (1) strength of salty taste, (2) taste satiety (sensation of taste satisfaction), (3) taste balance, and (4) good taste (overall judgment). Scores were assigned according to the following criteria.

+++: Very clear effect over the control

++: Clear effect over the control

+: Higher effect over the control

−: No clear effect or undesirable effect over the control

Excellent: Very clear good taste imparting effect over the control

Good: Clear good taste imparting effect over the control

Acceptable: Higher good taste imparting effect over the control

Poor: No clear good taste imparting effect, or undesirable good taste imparting effect over the control

Note that evaluations were made at the eating temperature of 75° C. to 65° C. The results are shown in Table 1.

TABLE 1
Confirmation of the Effect of Adding the Composition
for Reduced-Salt Food or Beverage at Various Concentrations
in Vegetable Soup System.

| Concentration of | Vegetable soup | | | |
|---|---|---|---|---|
| two components | | Taste satiety | | Overall |
| (intake | Strength of | (taste | Taste | good |
| concentration) | salty taste | satisfaction) | balance | taste |
| 0 ppm (Control) | − | − | − | Poor |
| 1 ppm | − | − | − | Poor |
| 10 ppm | − | + | + | Acceptable |
| 0.01% | − | ++ | + | Acceptable |
| 0.03% | − | ++ | ++ | Good |
| 0.05% | − | ++ | ++ | Good |
| 0.08% | − | ++ | ++ | Good |
| 0.1% | − | ++ | + | Acceptable |
| 0.2% | − | +++ | + | Acceptable |
| 0.3% | − | +++ | + | Acceptable |
| 0.4% | − | +++ | − | Poor |

From the results presented in Table 1, it was confirmed that the good taste imparting effect was exhibited when the total intake concentration of the two components in the vegetable soup system was higher than 1 ppm and less than 0.4%, while the strength of salty taste did not differ greatly in all test groups compared to the control. The range above 0.01% and less than 0.1% was found to be more desirable in terms of a taste balance. The effect was unnoticeable at or below 1 ppm. The addition was considered excessive at 0.4%, because it produced an odd flavor, including an irritating odor.

### Example 2

### Confirmation of the Effect of Adding the Composition for Reduced-Salt Food or Beverage at Various Concentrations in Chicken Soup System

### Preparation of Chicken Soup.

A wing (200 g), a leg (150 g), water (800 g), and salt (3.2 g) were placed in a pot, heated to boil over high heat, and stewed at low heat for 30 minutes after boiling. The scum was removed as it appeared while heating and stewing. After 30 minutes of stewing, the meat was taken out, and the broth was filtered through a cooking paper. The oil floating on the filtered liquid was skimmed, and the remaining liquid was obtained as a chicken soup (intake salt concentration 0.4%).

### Addition of the Composition for Reduced-Salt Food or Beverage to Chicken Soup at Various Concentrations.

A HVP (a dry powder obtained by spray drying an enzymatically hydrolyzed wheat solution (enzymatically hydrolyzed for at least 20 hours) after purifying the solution and removing a fraction with a molecular weight of 20,000 or more using a ultrafiltration membrane), and a yeast extract (“yeast extract No. 2,” bread yeast extract; Ajinomoto Co., Inc.) were added to the chicken soup in the same proportions to make the total intake concentration of the two components 1 ppm, 10 ppm, 0.01%, 0.03%, 0.05%, 0.08%, 0.1%, 0.2%, 0.3%, 0.4%, 0.5%, 0.6%, and 0.7%. A chicken soup without addition of these two components was used as a control.

Note that the control had a low intake salt content, and was characterized by a plain poor taste, and an unbalanced bad taste, compared to a soup that had an intake salt concentration of 0.8%, a common standard concentration. The composition for reduced-salt food of the present invention was added to this chicken soup that had a weakly salty, plain, disrupted taste to examine the effect of adding the composition, specifically the good taste imparting effect.

Sensory evaluations were made based on (1) strength of salty taste, (2) taste satiety (sensation of taste satisfaction), (3) taste balance, and (4) good taste (overall judgment). Scores were assigned according to the following criteria.

+++: Very clear effect over the control

++: Clear effect over the control

+: Higher effect over the control

−: No clear effect or undesirable effect over the control

Excellent: Very clear good taste imparting effect over the control

Good: Clear good taste imparting effect over the control

Acceptable: Higher good taste imparting effect over the control

Poor: No clear good taste imparting effect, or undesirable good taste imparting effect over the control

Note that evaluations were made at the eating temperature of 75° C. to 65° C.

The results are shown in Table 2.

TABLE 2
Confirmation of the Effect of Adding the Composition
for Reduced-Salt Food or Beverage at Various
Concentrations in Chicken Soup System.

| Concentration of | Chicken soup | | | |
|---|---|---|---|---|
| two components | | Taste satiety | | Overall |
| (intake | Strength of | (taste | Taste | good |
| concentration) | salty taste | satisfaction) | balance | taste |
| 0 ppm (control) | − | − | − | Poor |
| 1 ppm | − | − | − | Poor |
| 10 ppm | − | − | − | Poor |
| 0.01% | − | + | + | Acceptable |
| 0.03% | − | ++ | ++ | Good |
| 0.05% | − | ++ | ++ | Good |
| 0.08% | − | ++ | ++ | Good |
| 0.1% | − | ++ | + | Acceptable |
| 0.2% | − | +++ | + | Acceptable |
| 0.3% | − | +++ | + | Acceptable |
| 0.4% | − | +++ | + | Acceptable |
| 0.5% | − | +++ | + | Acceptable |
| 0.6% | − | +++ | + | Acceptable |
| 0.7% | − | +++ | − | Poor |

From the results presented in Table 2, it was confirmed that the good taste imparting effect was exhibited when the total intake concentration of the two components in the chicken soup system was higher than 10 ppm and less than 0.7%, while the strength of salty taste did not differ greatly in all test groups compared to the control. The range above 0.01% and less than 0.1% was found to be more desirable in terms of a taste balance. The effect was unnoticeable at or below 10 ppm. The addition was considered excessive at 0.7%, because it produced an odd flavor, including an irritating odor.

### Example 3

### Comparison of Individual Components and Combinations of the Composition for Reduced-Salt Food or Beverage in Vegetable Soup

The following individual components (0.08% each) were added to the vegetable soup prepared in Example 1.

1) A HVP (a dry powder obtained by spray drying an enzymatically hydrolyzed wheat solution (enzymatically hydrolyzed for at least 20 hours) after purifying the solution and removing a fraction with a molecular weight of 20,000 or more using a ultrafiltration membrane).

2) A HVP (a dry powder obtained by spray drying a desalted, concentrated solution of enzymatically hydrolyzed soybean).

3) A hydrolyzed animal protein (HAP) (a dry powder obtained by spray drying a deironized solution of enzymatically hydrolyzed pig gelatin).

4) Yeast extract (“yeast extract No. 2,” bread yeast extract, Ajinomoto Co., Inc.).

5) Yeast extract (yeast extract obtained by heating a mixture of a glutathione-containing yeast extract and sugar).

In the same manner, the following components were added in combination to the vegetable soup in a total concentration of 0.08%.

6) A HVP (a dry powder obtained by spray drying an enzymatically hydrolyzed wheat solution (enzyme-degraded for at least 20 hours) after purifying the solution and removing a fraction with a molecular weight of 20,000 or more using a ultrafiltration membrane), and a yeast extract (“yeast extract No. 2,” bread yeast extract; Ajinomoto Co., Inc.).

7) A HVP (a dry powder obtained by spray drying a desalted, concentrated solution of enzymatically hydrolyzed soybean), and a yeast extract (“yeast extract No. 2,” bread yeast extract; Ajinomoto Co., Inc.).

8) A HVP (a dry powder obtained by spray drying an enzymatically hydrolyzed wheat solution (enzymatically hydrolyzed for at least 20 hours) after purifying the solution and removing a fraction with a molecular weight of 20,000 or more using a ultrafiltration membrane), a yeast extract (“yeast extract No. 2,” bread yeast extract; Ajinomoto Co., Inc.), and a yeast extract (yeast extract obtained by heating a mixture of a glutathione-containing yeast extract and sugar).

9) A HAP (a dry powder obtained by spray drying a de-ionized solution of enzymatically hydrolyzed pig gelatin), and a yeast extract (“yeast extract No. 2,” bread yeast extract; Ajinomoto Co., Inc.).

10) A HAP (a dry powder obtained by spray drying a de-ionized solution of enzymatically hydrolyzed pig gelatin), a yeast extract (“yeast extract No. 2,” bread yeast extract; Ajinomoto Co., Inc.), and a yeast extract (yeast extract obtained by heating a mixture of a glutathione-containing yeast extract and sugar).

These components were added in the same proportions in the systems in which two or more components were added. Specifically, each component was added in 0.04% in 6), 7), and 9) in which two components were added. In 8) and 10) in which three components were added, each component was added in 0.027%. A vegetable soup without addition of the components was used as a control.

Note that the control had a low intake salt content, and was characterized by a plain poor taste, and an unbalanced bad taste, compared to a soup that had an intake salt concentration of 0.8%, a common standard concentration. The composition for reduced-salt food of the present invention was added to this vegetable soup that had a weakly salty, plain, disrupted taste to examine the effect of adding the composition, specifically the good taste imparting effect.

Sensory evaluations were made based on (1) strength of salty taste, (2) taste satiety (sensation of taste satisfaction), (3) taste balance, and (4) good taste (overall judgment). Scores were assigned according to the following criteria.

+++: Very clear effect over the control

++: Clear effect over the control

+: Higher effect over the control

−: No clear effect or undesirable effect over the control

Excellent: Very clear good taste imparting effect over the control

Good: Clear good taste imparting effect over the control

Acceptable: Higher good taste imparting effect over the control

Poor: No clear good taste imparting effect, or undesirable good taste imparting effect over the control

Note that evaluations were made at the eating temperature of 75° C. to 65° C. The results are shown in Table 3.

TABLE 3
Comparison of Individual Components and Combinations of the Composition for Reduced-Salt Food or Beverage in Vegetable
Soup.

| | | | | Vegetable soup | | | |
|---|---|---|---|---|---|---|---|
| | | | | | Taste satiety | | |
| | | | | Strength of salty | (taste | | Overall good |
| | | | | taste | satisfaction) | Taste balance | taste |
| Control (no addition) | | | | − | − | − | Poor |
| Individual | HVP | 1) | Enzymatically hydrolyzed wheat | − | + | − | Poor |
| components | | 2) | Enzymatically hydrolyzed bean | − | + | − | Poor |
| | HAP | 3) | Enzymatically hydrolyzed pig | − | + | − | Poor |
| | | | gelatin | | | | |
| | Yeast | 4) | Bread yeast extract | − | + | − | Poor |
| | extract | 5) | Glutathione-containing yeast + | − | + | − | Poor |
| | | | sugar | | | | |
| Combinations | HVP + | 6) | Enzymatically hydrolyzed wheat | − | ++ | ++ | Good |
| | yeast | | Bread yeast extract | | | | |
| | extract | 7) | Enzymatically hydrolyzed bean | − | ++ | ++ | Good |
| | | | Bread yeast extract | | | | |
| | | 8) | Enzymatically hydrolyzed wheat | − | +++ | +++ | Excellent |
| | | | Bread yeast extract | | | | |
| | | | Glutathione-containing yeast + | | | | |
| | | | sugar | | | | |
| | HAP + | 9) | Enzymatically hydrolyzed pig | − | ++ | − | Poor |
| | yeast | | gelatin | | | | |
| | extract | | Bread yeast extract | | | | |
| | | 10) | Enzymatically hydrolyzed pig | − | +++ | − | Poor |
| | | | gelatin | | | | |
| | | | Bread yeast extract | | | | |
| | | | Glutathione-containing yeast + | | | | |
| | | | sugar | | | | |

From the results of Table 3, it was confirmed that, while the strength of salty taste did not differ greatly in all test groups compared to the control, the effect was weaker with the HVP and the yeast extract alone, and that the good taste imparting effect was exhibited by the synergy of the two components. It was also found that adding the yeast extract obtained by heating a mixture of a glutathione-containing yeast extract and sugar could produce the effect more prominently. Specifically, it was possible to impart a more well-balanced flavor or taste.

### Example 4

### Confirmation of Optimum Proportions of Hydrolyzed Vegetable Protein and Yeast Extract

A HVP (a dry powder obtained by spray drying an enzymatically hydrolyzed wheat solution (enzymatically hydrolyzed for at least 20 hours) after purifying the solution and removing a fraction with a molecular weight of 20,000 or more using a ultrafiltration membrane), and a yeast extract (“yeast extract No. 2,” bread yeast extract; Ajinomoto Co., Inc.) were added in different proportions to the vegetable soup prepared in Example 1 to make the total intake concentration of the two components 0.08%. A vegetable soup without addition of these two components was used as a control. Note that the control had a low intake salt content, and was characterized by a plain poor taste, and an unbalanced bad taste, compared to a soup that had an intake salt concentration of 0.8%, a common standard concentration. The composition for reduced-salt food of the present invention was added to this vegetable soup that had a weakly salty, plain, disrupted taste to examine the effect of adding the composition, specifically the good taste imparting effect.

Sensory evaluations were made based on (1) strength of salty taste, (2) taste satiety (sensation of taste satisfaction), (3) taste balance, and (4) good taste (overall judgment). Scores were assigned according to the following criteria.

+++: Very clear effect over the control

++: Clear effect over the control

+: Higher effect over the control

−: No clear effect or undesirable effect over the control

Excellent: Very clear good taste imparting effect over the control

Good: Clear good taste imparting effect over the control

Acceptable: Higher good taste imparting effect over the control

Poor: No clear good taste imparting effect, or undesirable good taste imparting effect over the control

Note that evaluations were made at the eating temperature of 75° C. to 65° C. The results are shown in Table 4.

TABLE 4
Confirmation of Optimum Proportions of Hydrolyzed Vegetable Protein and Yeast Extract.

| Mixture No. | | 1 | 2 | 3 | 4 | 5 | 6 | 7 | 8 | 9 | 10 | 11 |
|---|---|---|---|---|---|---|---|---|---|---|---|---|
| A | HVP | 0 | 20 | 30 | 40 | 50 | 60 | 70 | 80 | 90 | 95 | 100 |
| | (Enzymatically | | | | | | | | | | | |
| | hydrolyzed wheat) | | | | | | | | | | | |
| B | Yeast extract | 100 | 80 | 70 | 60 | 50 | 40 | 30 | 20 | 10 | 5 | 0 |
| | (bread yeast extract) | | | | | | | | | | | |
| Sensory | Strength of salty | − | − | − | − | − | − | − | − | − | − | − |
| Evaluation | taste | | | | | | | | | | | |
| | Taste satiety | ++ | ++ | ++ | ++ | ++ | ++ | ++ | ++ | ++ | ++ | + |
| | (taste satisfaction) | | | | | | | | | | | |
| | Taste balance | − | + | + | + | ++ | ++ | + | + | + | ++ | − |
| | Overall good taste | Poor | Acceptable | Acceptable | Acceptable | Good | Good | Acceptable | Acceptable | Acceptable | Good | Poor |

From the results presented in Table 4, it was confirmed that, while the strength of salty taste did not differ greatly in all test groups compared to the control, the good taste imparting effect was present in the ranges 0≦A≦100 and 0≦B≦100, where A was the weight part of the mixed amount of the HVP, B was the weight part of the mixed amount of the yeast extract, and A+B=100. It was estimated from the patterns seen in Table 4 that the good taste imparting effect was present in the ranges 15≦A≦97 and 3≦B≦85, where A+B=100.

### Example 5

### Confirmation of Optimum Proportions of (A) HVP, (B) Yeast Extract, and (C) Component C Such as Amino Acid

A HVP (a dry powder obtained by spray drying an enzymatically hydrolyzed wheat solution (enzymatically hydrolyzed for at least 20 hours) after purifying the solution and removing a fraction with a molecular weight of 20,000 or more using a ultrafiltration membrane), a yeast extract (“yeast extract No. 2,” bread yeast extract; Ajinomoto Co., Inc.), and (C) a component such as an amino acid were added in different proportions to the vegetable soup prepared in Example 1 to make the total intake concentration of the three components 0.08%. A vegetable soup without addition of these three components was used as a control. Note that the control had a low intake salt content, and was characterized by a plain poor taste, and an unbalanced bad taste, compared to a soup that had an intake salt concentration of 0.8%, a common standard concentration. The composition for reduced-salt food of the present invention was added to this vegetable soup that had a weakly salty, plain, disrupted taste to examine the effect of adding the composition, specifically the good taste imparting effect.

Sensory evaluations were made based on (1) strength of salty taste, (2) taste satiety (sensation of taste satisfaction), (3) taste balance, and (4) good taste (overall judgment). Scores were assigned according to the following criteria.

+++: Very clear effect over the control

++: Clear effect over the control

+: Higher effect over the control

−: No clear effect or undesirable effect over the control

Excellent: Very clear good taste imparting effect over the control

Good: Clear good taste imparting effect over the control

Acceptable: Higher good taste imparting effect over the control

Poor: No clear good taste imparting effect, or undesirable good taste imparting effect over the control

Note that evaluations were made at the eating temperature of 75° C. to 65° C. The results are shown in Table 5.

TABLE 5
Confirmation of Optimum Proportions of (A) HVP, (B) Yeast Extract, and (C) Component Such as Amino Acid.

| Mixture No. | | 1 | 2 | 3 | 4 | 5 | 6 | 7 | 8 | 9 |
|---|---|---|---|---|---|---|---|---|---|---|
| A | HVP | 0 | 20 | 30 | 40 | 50 | 60 | 70 | 80 | 90 |
| | (enzymatically hydrolyzed wheat) | | | | | | | | | |
| B | Yeast extract (bread yeast extract) | 90 | 35 | 30 | 25 | 20 | 15 | 10 | 5 | 0 |
| C | Amino acid, etc. | 10 | 45 | 40 | 35 | 30 | 25 | 20 | 15 | 10 |
| Sensory Evaluation | Strength of salty taste | − | − | − | − | − | − | − | − | − |
| | Taste satiety | ++ | +++ | +++ | +++ | +++ | +++ | +++ | +++ | ++ |
| | (taste satisfaction) | | | | | | | | | |
| | Taste balance | − | + | ++ | +++ | ++ | ++ | +++ | ++ | − |
| | Overall good taste | Poor | Acceptable | Good | Excellent | Good | Good | Excellent | Good | Poor |

The component C (amino acid, etc.) in Table 5 was a mixture that contains at least one of sodium glutamate, alanine, methionine, sodium aspartate, arginine, lysine hydrochloride, sodium inosinate, trisodium citrate, succinic acid, potassium bitartrate, calcium lactate, sodium fumarate, dipotassium hydrogen phosphate, anhydrous potassium carbonate, and sorbitol.

From the results presented in Table 5, it was confirmed that, while the strength of salty taste did not differ greatly in all test groups compared to the control, the good taste imparting effect was present in the ranges 20≦A≦80, 5≦B≦35, and 15≦C≦45, where A was the weight part of the mixed amount of the HVP, B was the weight part of the mixed amount of the yeast extract, C was the weight part of the component C (amino acid, etc.), and A+B+C=100. It was estimated from the patterns seen in Table 5 that the good taste imparting effect was present in the ranges 10≦A≦85, 3≦B≦40, and 12≦C≦50, where A+B+C=100.

### INDUSTRIAL APPLICABILITY

The present invention relates to a composition for use in reduced-salt foods or beverages that include a mixture of a hydrolyzed vegetable protein and a yeast extract.

Where a numerical limit or range is stated herein, the endpoints are included. Also, all values and subranges within a numerical limit or range are specifically included as if explicitly written out.

Obviously, numerous modifications and variations of the present invention are possible in light of the above teachings. It is therefore to be understood that, within the scope of the appended claims, the invention may be practiced otherwise than as specifically described herein.

All patents and other references mentioned above are incorporated in full herein by this reference, the same as if set forth at length.

1. A composition for a reduced-salt food or beverage, comprising at least one hydrolyzed vegetable protein and at least one yeast extract.

2. A composition for a reduced-salt food or beverage, comprising at least one hydrolyzed vegetable protein and at least one yeast extract in relative amounts of 15≦A≦97 and 3≦B≦85, where
A is the weight part of the at least one hydrolyzed vegetable protein,
B is the weight part of the at least one yeast extract, and
A+B=100.

3. A composition for a reduced-salt food or beverage, comprising at least one hydrolyzed vegetable protein, at least one yeast extract, and one or more components selected from the group consisting of an amino acid, a salt of an amino acid, a nucleic acid, a salt of a nucleic acid, an organic acid, a salt of an organic acid, an inorganic salt, and a sugar alcohol.

4. A composition for a reduced-salt food or beverage, comprising at least one hydrolyzed vegetable protein, at least one yeast extract, and one or more components selected from the group consisting of an amino acid, a salt of an amino acid, a nucleic acid, a salt of a nucleic acid, an organic acid, a salt of an organic acid, an inorganic salt, and a sugar alcohol in relative amounts of 10≦A≦85, 3≦B≦40, and 12≦C≦50, where
A is the weight part of the at least one hydrolyzed vegetable protein,
B is the weight part of the at least one yeast extract,
C is the weight part of the total amount of said one or more components selected from the group consisting of an amino acid, a salt of an amino acid, a nucleic acid, a salt of a nucleic acid, an organic acid, a salt of an organic acid, an inorganic salt, and a sugar alcohol, and
A+B+C=100.

5. A composition for a reduced-salt food or beverage according to claim 1, wherein the at least one vegetable protein is obtained from one or more sources selected from the group consisting of a cereal, a bean, and a nut.

6. A composition for a reduced-salt food or beverage according to claim 1, wherein the at least one hydrolyzed vegetable protein is produced by a method that includes one or more steps corresponding selected from steps (a) to (i),
(a) hydrolyzing a vegetable protein at a pH of 6 or less,
(b) hydrolyzing a vegetable protein at a pH of 8 or more,
(c) adding an alkaline solution to a hydrolyzed protein solution to neutralize acid, then removing sodium chloride,
(d) enzymatically hydrolyzing a vegetable protein at a temperature of 20 to 40° C. and a pH of 6 to 9 using a liquid rice malt or a solid rice malt,
(e) hydrolyzing a vegetable protein without a salt,
(f) separating koji mold cells from a protein hydrolysis solution by centrifugation or filtration and drying the obtained solution,
(g) decoloration of a hydrolyzed vegetable protein by membrane treatment and/or with activated carbon,
(h) concentrating a hydrolyzed vegetable protein at a pH of 8 or more, or
(i) removing a fraction with a molecular weight of 20,000 or more from a hydrolyzed vegetable protein using a membrane, a column, or electrophoresis.

7. A composition for a reduced-salt food or beverage according to claim 1, wherein the at least one yeast extract is produced by using a yeast of the genus Saccharomyces, or a torula yeast (the genus Candida).

8. A composition for a reduced-salt food or beverage according to claim 7, wherein the Saccharomyces yeast is Saccharomyces cerevisiae.

9. A composition for a reduced-salt food or beverage according to claim 1, further comprising at least one second yeast extract obtained by heating a mixture of a glutathione-containing yeast extract and sugar.

10. A composition for a reduced-salt food or beverage according to claim 1, wherein the at least one yeast extract is obtained by using any one of an autolysis method, an acid degradation method, and an enzyme degradation method.

11. A composition for a reduced-salt food or beverage according to claim 1, wherein the at least one yeast extract has a total nitrogen content of 7% or less.

12. A composition for a reduced-salt food or beverage according to claim 3, which comprises at least one component selected from the group consisting of sodium glutamate, alanine, methionine, sodium aspartate, arginine, and lysine hydrochloride.

13. A composition for a reduced-salt food or beverage according to claim 3, which comprises sodium inosinate.

14. A composition for a reduced-salt food or beverage according to claim 3, which comprises at least one component selected from the group consisting of trisodium citrate, succinic acid, potassium bitartrate, calcium lactate, and sodium fumarate.

15. A composition for a reduced-salt food or beverage according to claim 3, which comprises at least one component selected from the group consisting of dipotassium hydrogen phosphate, and anhydrous potassium carbonate.

16. A composition for a reduced-salt food or beverage according to claim 3, which comprises sorbitol.

17. A food or beverage, which comprises a composition for a reduced-salt food or beverage according to claim 1, in an amount of 5 ppm or more and 0.65% or less at the time of eating or drinking.

18. A reduced-salt food, which comprises a composition according to claim 1 in a reduced-salt food or beverage that has a 25% or higher percentage reduction of an intake amount of salt or an intake amount of sodium.

19. A method of improving the taste and flavor of a reduced-salt food or beverage, comprising adding an effective amount of a composition according to claim 1 to a reduced-salt food or beverage.
